(19) United States
(12) Patent Application Publication
(10) Pub. No.: US 2005/0229403 A1
(43) Pub. Date: Oct. 20, 2005

(54) Method and apparatus for cutting materials

(76) Inventor: Bob Manzano Diaz, Beaverton, OR (US)

Correspondence Address: CHALKER FLORES, LLP, 12700 PARK CENTRAL, STE. 455, DALLAS, TX, 75251, US

(21) Appl. No.: 10/932,400

(22) Filed: Sep. 2, 2004

Related U.S. Application Data
(63) Continuation-in-part of application No. 29/189,575, filed on Sep. 8, 2003, now Pat. No. D501386.

(51) Int. Cl. B26B 19/44

(52) U.S. Cl. 30/294; 30/293

(57) ABSTRACT

The present invention includes a cutting apparatus, method and system for cutting, trimming and deburring an edge or surface. One embodiment of the present invention includes an apparatus having a first cutting member holder including one or more slots extending inwardly from one or more ends, an upper member attached to the first cutting member holder, whereby a longitudinal grove is formed between the first cutting member holder and the upper member and a cutting surface disposed in or about the first cutting member holder, wherein the cutting surface comprises two or more cutting members which are angled relative to each other and one or more cutting members that extend into the one or more slots.

### CROSS-REFERENCE TO RELATED APPLICATIONS

This application claims priority to U.S. Design patent application Ser. No. 29/189,575, filed Sep. 8, 2003.

### TECHNICAL FIELD OF THE INVENTION

The present invention relates, in general, to the field of tools, and in particular, a process and apparatus for cutting materials.

### BACKGROUND OF THE INVENTION

Without limiting the scope of the invention, the background of the invention is described in connection with cutting tools, as an example. Many tools are used for cutting, trimming and deburring the edges or surfaces of boxes, cartons and other objects made of various materials. Typical uses of cutting tools include preparation of articles for shipping (e.g., cutting strapping, ribbon, tape or twine, packaging of paper products and film); preparation of materials (e.g., film loading, unloading or processing); merchandising (e.g., including the removal of products form containers and preparation of products for sale); and emergency procedures (e.g., safety belts removal of accident victims, bandage removal and emergency clothing removal).

Commonly used cutting tools include utility knives or other single blade cutting tools, which are sometimes extremely difficult to control the depth of penetration of the material while cutting. This difficulty often results in the unintended damage to the material being cut, the underlying material, the contents of the container or carton, and more seriously, injury to the user. Personal injury can result from the accidental contact with the blade or repetitive or extended use of the cutting tool (e.g., muscle, repetitive stress injury, etc.). Moreover, the user is often required to cut materials at awkward orientations that require excess movement of the cutter. Additionally, as single blade cutting tools are used, the blade becomes dull and possibly damaged.

As a consequence of the foregoing, a longstanding need exists among users for a method and apparatus that more precisely controls cutting, trimming and deburring of a surface or edge while protecting the user from injury.

### SUMMARY OF THE INVENTION

In accordance with the present invention, a method and apparatus are provided that allows more precise cutting, trimming, or deburring of materials using a multi-blade cutting tool. The present invention provides a cutting apparatus for cutting, trimming and deburring the edges or surface of objects that allows access to the cutting members and facilitates the movement of the cutting apparatus along the surface of the box, carton or other material to be cut, while retaining the protective features that protects the user from injury and allowing the cutting apparatus to be ready for immediate action without undue manipulation.

For example, the first blade can be used to cut the tape sealing the top of the box and the edges of the box. The second blade can then be used to cut the tape sealing the top flaps of the box. The user can make these cuts without twisting his or her hand at an odd angle that may cause injury. Moreover, the first cutting member holder prevents the cuts from damaging the contents of the box. In another example, the first blade can be used to cut the top flaps of the box, and the second blade can then be used to cut the remaining flaps of the box.

One embodiment of the present invention includes a cutting apparatus having a first cutting member holder, one or more first cutting members, a second cutting member holder and one or more second cutting members. The first cutting member holder includes one or more slots extending inwardly. The one or more first cutting members are disposed in or about the first cutting member holder and extend into the one or more slots. The second cutting member holder is disposed in or about the first cutting member holder and extends generally perpendicular to the one or more first cutting members. The one or more second cutting members are disposed on or about the second cutting member holder. The cutting apparatus may also include an upper member connected to the second cutting member holder and extending generally parallel to the first cutting member holder, whereby one or more longitudinal groves are formed between the upper member and the first cutting member holder.

Another embodiment of the present invention provides a cutting apparatus having a first longitudinal member having one or more slots parallel to a longitudinal axis of the first longitudinal member. A second longitudinal member is attached generally perpendicular to a top surface of the first longitudinal member. A first cutting member is disposed in or about the one or more slots, and a second cutting member is disposed on or about an edge of the second member. In one embodiment, the first longitudinal member and second longitudinal member are substantially planar. Additionally, the first longitudinal member and the second longitudinal member can form an integrated blade holder.

In addition the present invention provides a cutting apparatus that includes a first planar member having a leading edge and one or more longitudinal slots in the leading edge. A second planar member is attached to a top surface of the first planar member at a generally perpendicular angle to the leading edge and the top surface of the first planar member. A first cutting member is disposed in or about the one or more longitudinal slots and a second cutting member disposed on or about a leading edge of the second member. In one embodiment, the first planar member and the second planar member form an integrated blade holder.

The present invention also provides a method of making a cutting apparatus including the steps of preparing an assembly having a first cutting member holder having one or more slots extending inwardly. One or more first cutting members then positioned to extend into the one or more slots. The one or more first cutting members are disposed in or about the first cutting member holder. One or more second cutting members are oriented to extend generally perpendicular to the one or more first cutting members. The one or more second cutting members are then disposed in or about the first cutting member holder.

Additionally, the present invention includes an automated cutting system having a transporting mechanism, and a cutting apparatus. The transporting mechanism including a conveyer system, whereby an object is transported through a path to a cutting apparatus designed to contact the transported object. The conveyer system may be an endless track type conveyor belt, a series of rollers, a feed table or a cart. The transporting mechanism may include an electric motor that drives the conveyer system. The system may include a control mechanism (e.g., a computer, an electronic eye, a counter or a manual control) that controls the movement of materials towards the cutting apparatus and away from the cutting apparatus.

The cutting apparatus includes a first longitudinal member having one or more slots parallel to a longitudinal axis of the first longitudinal member, a second longitudinal member attached generally perpendicular to a top surface of the first longitudinal member, a first cutting member disposed in or about the one or more slots, and a second cutting member disposed on or about an edge of the second member. In one embodiment, the first longitudinal member and second longitudinal member are substantially planar. Additionally, the first longitudinal member and the second longitudinal member can form an integrated blade holder.

Additionally, the cutting apparatus may be attached to the automated cutting system through a flexible member, to assist the movement of the cutting apparatus. The cutting apparatus may be integrated into an automated system (e.g., a conveyer belt, roller mechanism, table or other mechanisms known in the art) to facilitate the movement of materials to be cut.

The present invention is described in detail below with reference to the accompanying drawings.

### BRIEF DESCRIPTION OF THE DRAWINGS

For a more complete understanding of the features and advantages of the present invention, reference is now made to the detailed description of the invention along with the accompanying figures and in which:

FIG. 1 illustrates certain features of a cutting apparatus according to an embodiment of the present invention;

FIG. 2 is a top view of a portion of the apparatus shown in FIG. 1;

FIG. 3 is a side view of a portion of the apparatus shown in FIG. 1;

FIG. 4 is a bottom view of a portion of the apparatus shown in FIG. 1;

FIG. 5 is an end view of a portion of the apparatus shown in FIG. 1;

FIG. 6 is a detailed view of a portion of the apparatus shown in FIG. 1;

FIG. 7 is a side view of a portion of the first cutting member holder of the apparatus shown in FIG. 1;

FIG. 8 is an upper member view of a portion of the first cutting member holder of the apparatus shown in FIG. 1;

FIG. 9 is a side view of a portion of the handle of the apparatus shown in FIG. 1;

FIG. 10 is a different embodiment of a portion of the handle of the apparatus shown in FIG. 1;

FIG. 11 illustrates certain features of a cutting apparatus according to an alternate embodiment of the present invention; and

FIG. 12 illustrates a top view of certain features of an automated cutting system.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The terminology used and specific embodiments discussed herein are merely illustrative of specific ways to make and use the invention and do not delimit the scope of the invention.

In accordance with the present invention, a method and apparatus are provided that allows more precise cutting, trimming, or deburring of materials using a multi-blade cutting tool. The present invention provides a cutting apparatus for cutting, trimming and deburring the edges or surface of objects that allows access to the cutting members and facilitates the movement of the cutting apparatus along the surface of the box, carton or other material to be cut, while retaining the protective features that protects the user from injury and allowing the cutting apparatus to be ready for immediate action without undue manipulation.

For example, the first blade can be used to cut the tape sealing the top of the box and the edges of the box. The second blade can then be used to cut the tape sealing the top flaps of the box. The user can make these cuts without twisting his or her hand at an odd angle that may cause injury. Moreover, the first cutting member holder prevents the cuts from damaging the contents of the box. In another example, the first blade can be used to cut the top flaps of the box, and the second blade can then be used to cut the remaining flaps of the box.

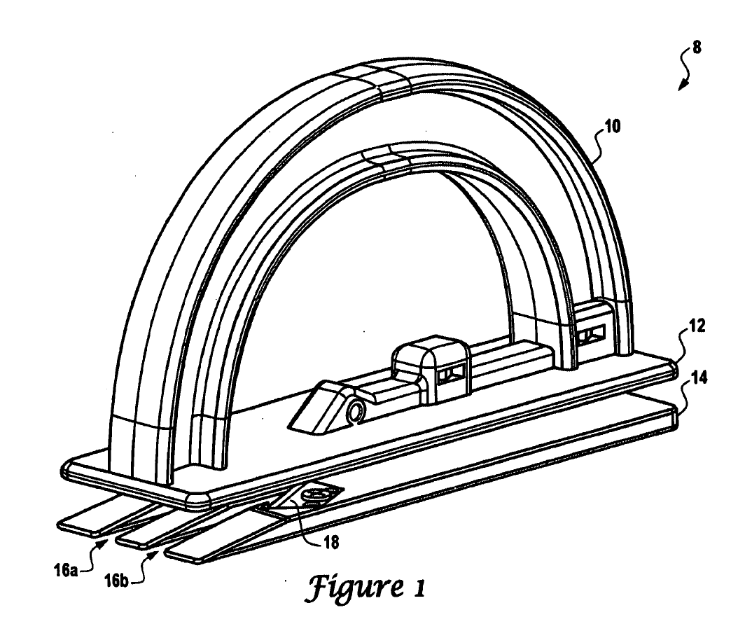

With reference to FIG. 1, a cutting apparatus 8, in accordance with the present invention is shown and includes a handle 10 disposed on or about an upper member 12. Alternatively, the handle 10 can be attached removably or molded in the upper member 12. A first cutting member holder 14 is attached generally parallel to the upper member 12. The first cutting member holder 14 has one or more slots 16a and 16b extending inward from one end. The one or more slots 16a and 16b can be located at either or both ends of the first cutting member holder 14. One or more first cutting members 18 are disposed in or about the first cutting member holder 14 and extend into the one or more slot 16a and 16b. The first cutting member holder 14 can be configured in different combinations of one or more slots 16a and 16b with one or more first cutting members 18. In some instances, the first cutting member holder 14 has one or more first cutting members 18 extending in each of the one or more slots 16a and 16b. In other instances the first cutting member holder 14 has one first cutting member 18 extend into all of the one or more slots 16a and 16b (e.g., one slot and one first cutting member, one slot and multiple first cutting members, multiple slots and one first cutting member, multiple slots and multiple first cutting members).

The one or more first cutting members 18 are disposed in or about the first cutting member holder 14 and extend partially into the one or more slots 16a and 16b. The one or more first cutting members 18 can be fit frictionally in or about the first cutting member holder 14, molded into the first cutting member holder 14 or removably attached in or about the first cutting member holder 14. The one or more first cutting members 18 can be a conventional razor, a blade, a serrated blade, a metal wire, a plastic fiber, a composite fiber, a plastic blade, a composite material or some other device having an surface that can be used for cutting. Additionally, the one or more first cutting members may be of similar or different materials. The cutting apparatus 8, the handle 10, the upper member 12 and the first cutting member holder 14 can be individually constructed of plastic, polymer, carbon nanotubes, fiberglass, metal, composite, graphite, stone, wood or other suitable materials or a combination thereof.

Alternatively, the present invention can include a cutting apparatus that having a first planar member having a leading edge and one or more longitudinal slots in the leading edge, a second planar member attached to a top surface of the first planar member at a generally perpendicular angle to the leading edge and the top surface of the first planar member, a first cutting member disposed in or about the one or more longitudinal slots and a second cutting member disposed on or about a leading edge of the second member. In one embodiment, the first planar member and the second planar member form an integrated blade holder.

Likewise, the present invention can include a cutting apparatus having a first longitudinal member having one or more slots parallel to a longitudinal axis of the first longitudinal member, a second longitudinal member attached generally perpendicular to a top surface of the first longitudinal member, a first cutting member disposed in or about the one or more slots, and a second cutting member disposed on or about an edge of the second member. In one embodiment, the first longitudinal member and second longitudinal member are substantially planar. Additionally, the first longitudinal member and the second longitudinal member can form an integrated blade holder.

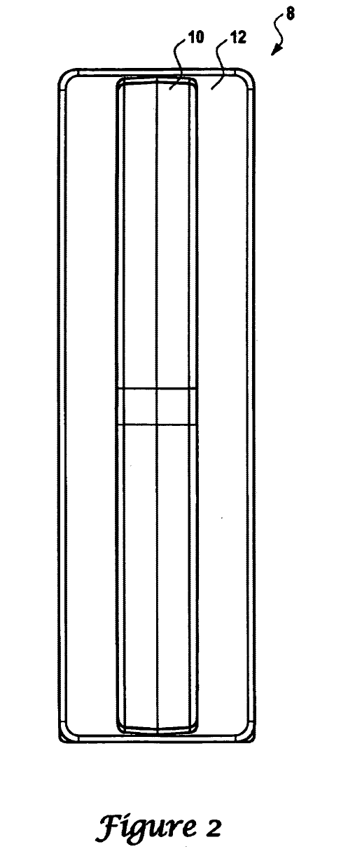

FIG. 2 is a top view of a portion of the apparatus 8 shown in FIG. 1. The cutting apparatus 8 includes the upper member 12 attached to a handle 10 extending substantially parallel to the first cutting member holder 14. Alternatively, the handle 10 can be positioned to form a right or left angle of between about one and ninety degrees relative to the first cutting member holder 14.

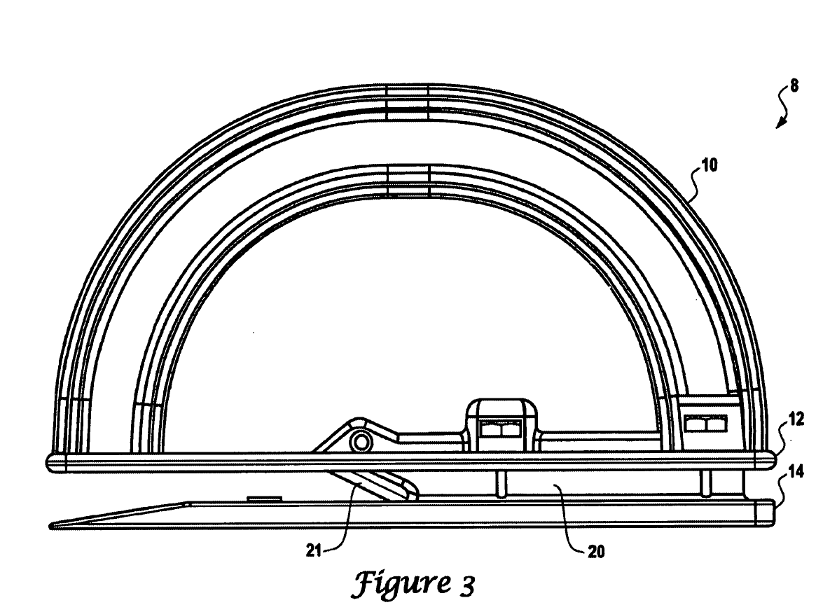

With respect to FIG. 3, is a side view of a portion of the apparatus 8 shown in FIG. 1, the handle 10 is disposed on or about the upper member 12. The upper member 12 is connected to the first cutting member holder 14 through a second cutting member holder 20, whereby the upper member 12 and the first cutting member holder 14 are generally parallel to one another.

The first cutting member holder 14 can taper outwardly, whereby the thickness at the middle of the first cutting member holder 14 is greater than the thickness at the end of the first cutting member holder 14. The first cutting member holder 14 can taper outwardly at both ends, whereby the thickness at the middle of the apparatus 8 is greater than the thickness at the ends of the first cutting member holder 14. The taper forms an angle, which can be between about 0 and 90 degrees depending on the thickness of the first cutting member holder 14 at the middle and at the ends. Additionally, the taper can be linear or can vary as a function of distance. The thickness on each end of the first cutting member holder 14 may be varied independently of the other, whereby the angle formed on one end may differ from the angle on the other end.

The second cutting member holder 20 is generally perpendicular to the first cutting member holder 14. Alternatively, the second cutting member holder 20 can be positioned to form a right or left angle of between about one and ninety degrees relative to the first cutting member holder 14. One or more second cutting members 21 are disposed on or about the second cutting member holder 20. The one or more second cutting members 21 can be fitted frictionally, removably secured in or about the second cutting member holder 20 or molded in or about the apparatus 8. The one or more second cutting members 21 form an angle with the first cutting member holder 14 that is between about zero and one hundred and eighty degrees. In one specific example, the one or more second cutting members 21 are positioned to form an angle of about twenty five degrees relative to the first cutting member holder 14. The one or more second cutting members 21 can be positioned on one end or both ends of the second cutting member holder 20. The one or more second cutting member 21 can be a conventional razor, a blade, a serrated blade, a metal wire, a plastic fiber, a composite fiber, a plastic blade, a composite material or some other device having an surface that can be used for cutting. The second cutting member holder 20 can be constructed from a material selected from the group consisting of polymers, plastics, alloys, metals, composites, graphite, stone, wood or combination thereof.

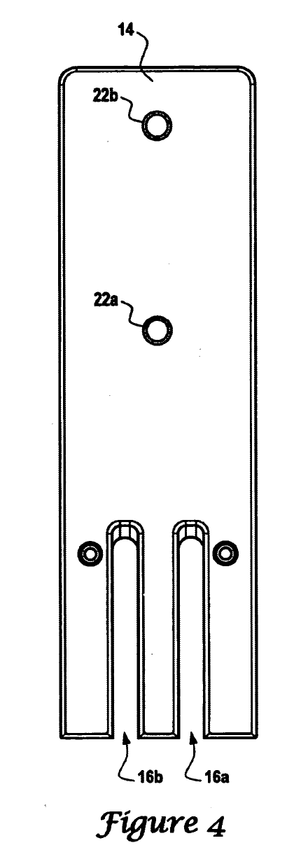

FIG. 4 illustrates a bottom view of a portion of the apparatus 8 shown in FIG. 1. The first cutting member holder 14 has one or more slots 16a and 16b, which extend inwardly from the end of the first cutting member holder 14. The one or more slots 16a and 16b extend through the first cutting member holder 14, however the one or more slots can extend partially into but not through the first cutting member holder 14. The one or more slots 16a and 16b are positioned generally parallel to each other and to the first cutting member 14. However, the one or more slots 16a and 16b can be at an angle between about 1 and 90 degrees relative to the first cutting member holder 14, with each of the one or more slots 16a and 16b having the same or different angles. The shape of the slots 16a and 16b can also be configured in different orientations, wherein the one or more slots 16a and 16b have a surface that is rounded, flat, pointed or combination thereof. One or more first cutting member holder securing holes 22a and 22b extend through the first cutting member holder 14. The one or more first cutting member holder securing holes 22a and 22b can be flush, tapered, or recessed below the surface maintaining a flush first cutting member holder 14 surface.

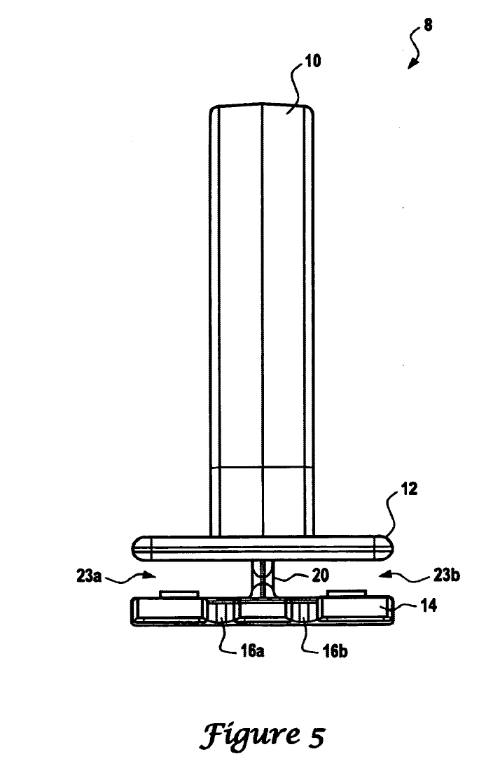

Now referring to FIG. 5, an end view of a portion of the apparatus 8 shown in FIG. 1 is illustrated. The handle 10 is disposed on or about the upper member 12 extending generally perpendicular thereto. However, the handle 10 may be positioned at any angle between zero and one hundred and eighty degrees relative to the upper member 12. The upper member 12 is attached to the second cutting member holder 20 and first cutting member holder 14, whereby forming one or more longitudinal groves 23a and 23b between the upper member 12 and the first cutting member holder 14. The second cutting member holder 20 is positioned generally perpendicular relative to the upper member 10 and the first cutting member holder 14. Alternatively, the second cutting member holder 20 may be positioned at any angle between zero and one hundred and eighty degrees relative to the first cutting member holder 14. The first cutting member holder 14 has one or more slots 16a and 16b, which extends through the first cutting member holder 14 and extends inwardly from the end of the first cutting member holder 14.

Additionally, the first cutting member holder 14 has a right side 23a and a left side 23b, which can differ in thickness, whereby a slant is formed from the a right side 23a of the first cutting member holder 14 to the left side 23b of the first cutting member holder 14. The slant forms an angle, which can be between about 0 and 90 degrees depending on the thickness of the first cutting member holder 14 at the a right side 23a and the left side 23b. The first cutting member holder 14 can slant toward both sides, wherein the thickness in the middle is different than the thickness at the a right side 23a and the left side 23b. Furthermore, the thickness on each side of the first cutting member holder 14 may be varied independently of the other, whereby the angle formed on one side may differ from the angle on the other side.

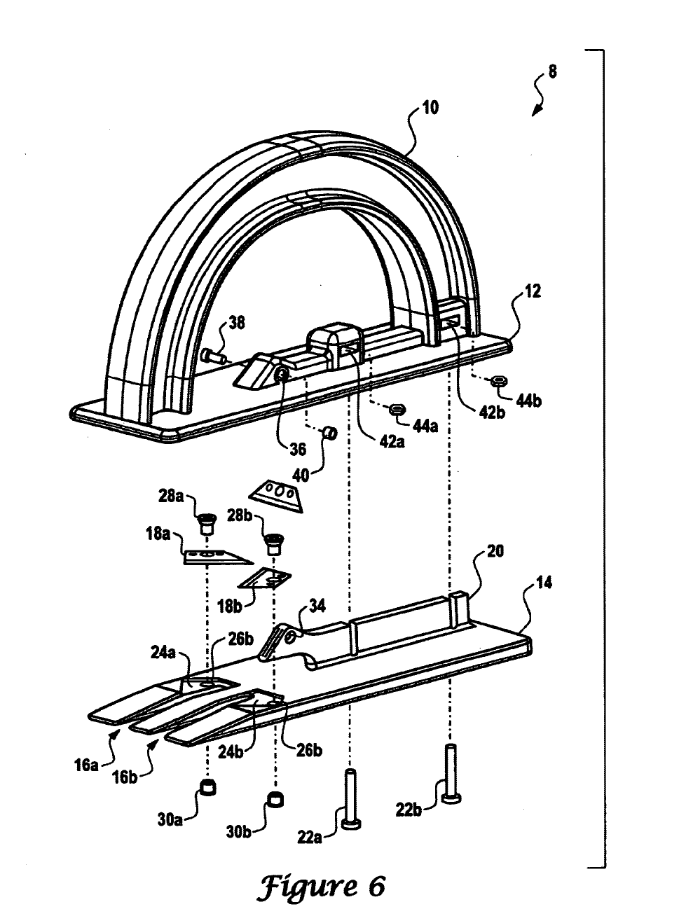

FIG. 6 is a detailed view of a portion of the apparatus 8 shown in FIG. 1. The first cutting member holder 14 has one or more slots 16a and 16b, which extend through the first cutting member holder 14 and extend inwardly from the end of the first cutting member holder 14. The first cutting member holder 14 tapers outwardly, whereby the thickness at the middle of the first cutting member holder 14 is greater than the thickness at the end of the first cutting member holder 14.

The one or more first cutting members 18a and 18b are disposed in or about the first cutting member holder 14 and extend partially into the one or more slots 16a and 16b respectively. The first cutting member holder 14 can be configured in different combinations of one or more slots 16a and 16b in combination with one or more first cutting members 18a and 18b. In some instances, the one or more slots 16a and 16b can extend through the first cutting member holder 14 and have a first cutting members 18a extending into slot 16a, and a first cutting members 18b extending into slot 16b. Others embodiments may have multiple one first cutting member 18a and 18b placed in one slot 16a or one cutting member 18a extending into all of the one or more slots 16a and 16b. The first cutting member holder 14 has one or more slots 16a and 16b extend outwardly. The one or more slots 16a and 16b can have one or more first cutting member 18a and 18b disposed thereon. The one or more first cutting member 18a and 18b extend partially into the one or more slots 16a and 16b, thereby forming an angle relative to the one or more slot 16a and 16b and angle between the one or more first cutting member 18a and 18b can differ between the one or more slots 16a and 16b. The angle formed between the one or more slot 16a and 16b and the one or more first cutting member 18a and 18b can be either a right angle or a left angle of between about zero and ninety degrees. In one example, the angle formed between the one or more slots 16a and 16b and the one or more first cutting member 18a and 18b is about thirty degrees.

The first cutting member holder 14 can have one or more slots 16a and 16b and one or more first cutting members 18a and 18b. The combination of one or more slots 16a and 16b and one or more first cutting members 18a and 18b may form numerous permutations (e.g., one slot and one first cutting member, one slot and multiple first cutting members, multiple slots and one first cutting member, multiple slots and multiple first cutting members). Alternatively, multiple one or more first cutting members 18a and 18b may be parallelly aligned and extending into one or more one or more slots 16a and 16b.

The first cutting member holder 14 incorporates one or more first cutting member recesses 24a and 24b, whereby the one or more first cutting members 18a and 18b contacts the one or more first cutting member recesses 24a and 24b. The one or more first cutting member securing apertures 26a and 26b are located within the one or more first cutting member recesses 24a and 24b respectively and extends through the first cutting member holder 14. The one or more first cutting member securing bolts 28a and 28b extend through the one or more first cutting members 18a and 18b and the one or more first cutting member securing apertures 26a and 26b and attach to the one or more first cutting member securing nuts 30a and 30b respectively, whereby one or more first cutting members 18a and 18b are secured to the first cutting member holder 14 and extending partially into the one or more slots 16a and 16b. Other fasteners common in the art (e.g., screws, bolts, rivets, molding, fitting frictionally and pins) can also be used to secure the one or more first cutting members 18a and 18b to the first cutting member holder 14. In other embodiments, the one or more first cutting member securing aperture 26a and 26b can extent partially into the first cutting member holder 14, whereby a screw may be used to secure the one or more cutting member 18a and 18b.

A second cutting member holder 20 extends generally perpendicularly from the first cutting member holder 14. However, the second cutting member holder 20, may extend at an angle from one to one hundred and eighty degrees relative to the first cutting member holder 14. The second cutting member holder 20 contains a second cutting member securing aperture 34. The second cutting member holder 20 can be configured to fit one or more second cutting members 21. The one or more second cutting members 21 can be configured to form an angle between one and one hundred and eighty degrees relative to the longitudinal the first cutting member holder 14.

The upper member 12 contains an upper member cutting member securing aperture 36 that fits the second cutting member holder 20. The mating of upper member 12 and the second cutting member holder 20 align the second cutting member securing aperture 34 with the upper member cutting member securing aperture 36. The upper member cutting member securing bolt 38 extends through the upper member cutting member securing aperture 36 and through the second cutting member securing aperture 34 in the second cutting member holder 20 and into a upper member cutting member securing nut 40. Additionally, other mechanisms can also be used to secure the first cutting member holder 14 (e.g., screws, glues, epoxy, fitting frictionally or a pin locking mechanism). The upper member 12 is also secured to the first cutting member holder 14 and the second cutting member holder 20 through one or more first cutting member holder securing bolts 22a and 22b extend through the first cutting member holder 14 and into one or more upper member securing nuts 44a and 44b associated with one or more upper member securing enclosure 42a and 42b located in or about the upper member 12. However, other mechanisms can also be used to secure the first cutting member holder 14 (e.g., screws, glues, epoxy, fitting frictionally or a pin locking mechanism).

The handle 10 may be disposed on or about the upper member 12 extending substantially parallel to the first cutting member holder 14. The handle 12 can be disposed on or about the first cutting member holder 14 or removably attached to the first cutting member holder 14. The handle 12 can be shaped or configured in any variety of ways and angles or can be absent altogether or can include one or more handles. The handle 12 can have a general “U” shape contacting the first cutting member holder 14 in two or more places, an ergonomically shape or even a yoke shape.

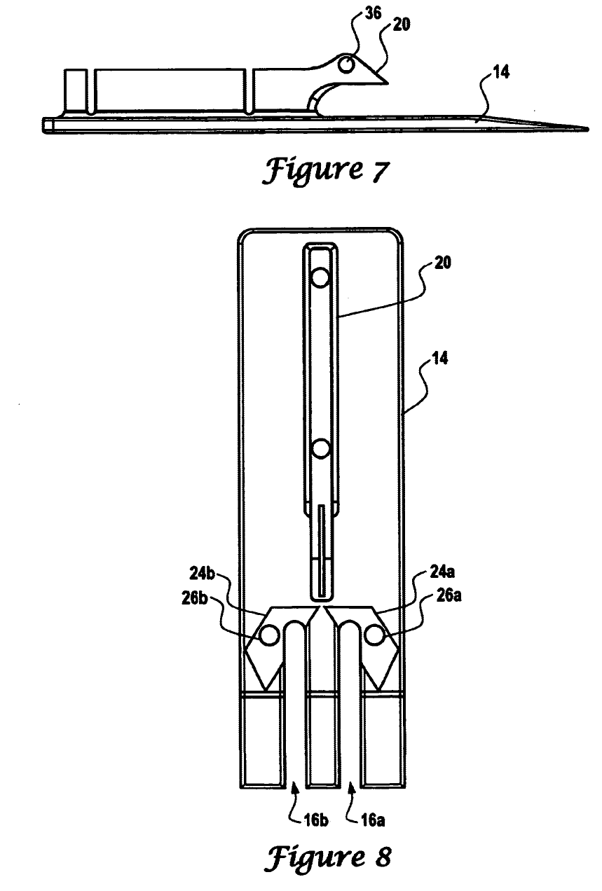

With respect to FIG. 7, a side view of a portion of the cutting apparatus 8 is shown. The first cutting member holder 14 tapers outwardly, whereby the thickness at the middle of the first cutting member holder 14 is greater than the thickness at the end of the first cutting member holder 14. A second cutting member holder 20 extends generally perpendicularly from the first cutting member holder 14 and contains a second cutting member securing aperture 34. The second cutting member holder 20 is designed to fit one or more second cutting members.

Referring to FIG. 8, a top view of a portion of the apparatus 8 shown in FIG. 1 is shown. The first cutting member holder 14 has one or more slots 16a and 16b extending inwardly from the end of the first cutting member holder 14. The first cutting member holder 14 incorporates one or more first cutting member recesses 24a and 24b, designed to fit one or more first cutting members (not shown). The one or more first cutting member recesses 24a and 24b extend partially into the one or more slots 16a and 16b. One or more first cutting member securing apertures 26a and 26b are located within the one or more first cutting member recesses 24a and 24b respectively and extends through the first cutting member holder 14. The one or more first cutting member securing apertures 26a and 26b can extent partially into each one or more slots 16a and 16b. Alternatively, one first cutting member securing apertures 24 can extent partially into one or more slots 16a and 16b. The second cutting member holder 20 extends generally perpendicularly from the first cutting member holder 14.

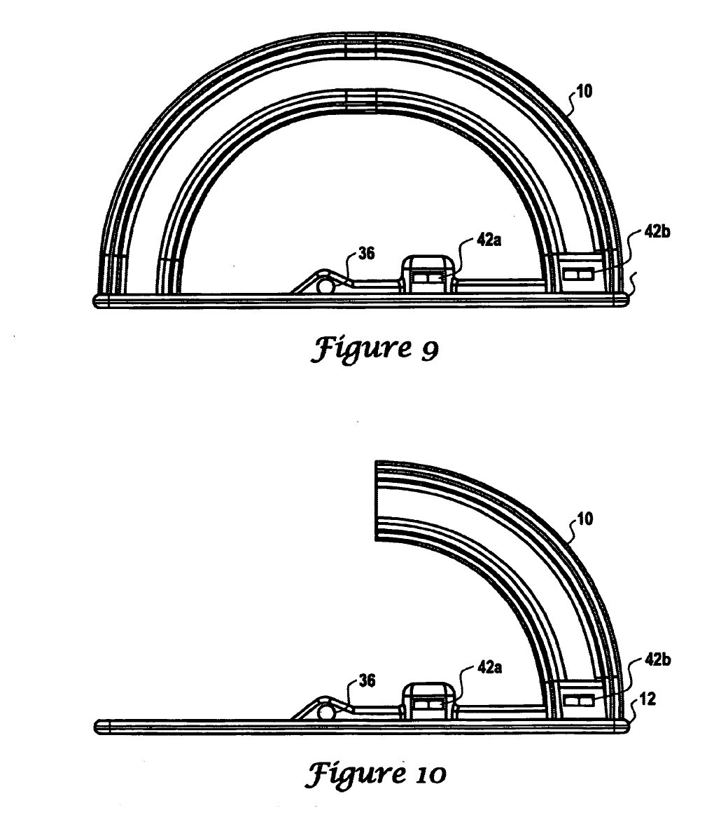

FIGS. 9 and 10 illustrate side views of different embodiments of a portion of the handle 12 of the apparatus 8 shown in FIG. 1. The handle 10 is disposed on or about the upper member 12. The handle 10 may have a general “U” shape or a pistol shape. However, other shapes can also be employed (e.g., knob, hand grip, ergonomic shape or yoke). Additionally the handle 12 can be shaped or configured in any variety of ways and at different angles or can be absent altogether or can include one or more handles. Furthermore, the handle 10 can be coated with rubber, polymer, plastic, vinyl, leather, cloth, natural or synthetic material. The upper member 12 contains an upper member cutting member securing aperture 36, whereby the second cutting member holder (not shown) mates with the upper member 12. The upper member 12 contains one or more upper member securing enclosure 42a and 42b located in or about the upper member 12, whereby the upper member securing nuts can be associated with the one or more upper member securing enclosure 42a and 42b. However, other mechanisms can also be used to secure the upper member 12 to the first cutting member holder (not shown) or to an automated cutting system (not shown).

With reference to FIG. 11, a perspective view of the cutting apparatus 8 is shown that including an upper member 12 attached to a first cutting member holder 14 and extending generally parallel to a first cutting member holder 14, whereby one or more longitudinal groves 23a are formed between the upper member 12 and the first cutting member holder 14. The cutting apparatus 8, the upper member 10 and the first cutting member holder 14 can be constructed of plastic, metal, composite, graphite, stone, wood or other suitable materials or a combination thereof. The upper member 10 can be configured to a convenient size, which may be smaller, larger or the same size as the first cutting member holder 14. The first cutting member holder 14 has one or more slots 16a and 16b extending through the first cutting member holder 14 and extending inward from one end. The first cutting member holder 14 can have one or more slots 16a and 16b, which can be located at either or both ends of the first cutting member holder 14. One or more first cutting members 18a is disposed in or about the first cutting member holder 14 extending partially into the one or more slots 16a and 16b.

The one more first cutting members 18a can be fit frictionally in or about the first cutting member holder 14, molded into the first cutting member holder 14 or removably attached in or about the first cutting member holder 14. The one or more first cutting members 18a can be a conventional razor, a blade, a serrated blade, a metal wire, a plastic fiber, a composite fiber, a plastic blade, a composite material or some other device having an surface that can be used for cutting. The one or more first cutting members 18a may be of similar or different types. The upper member 12 contains an upper member cutting member securing aperture 36, whereby the second cutting member holder (not shown) mates with the upper member 12. The upper member 12 contains one or more upper member securing enclosure 42a and 42b located in or about the upper member 12. The upper member securing nuts (not shown) can be associated with the one or more upper member securing enclosure 42a and 42b, whereby securing the upper member 12 to the first cutting member holder 14. Alternatively, the one or more upper member securing enclosure 42a and 42b can be used to secure the cutting apparatus 8 to an automated system (not shown).

An alternate embodiment contains a first cutting member holder 14 having one or more slots 16a and 16b extending through the first cutting member holder 14 and extending inward from one end and a unibody cutting surface (not shown) disposed in or about the first cutting member holder 14 and extends into the one or more slots 16a and 16b. The unibody cutting surface (not shown) includes one or more first cutting members (not shown) and one or more second cutting member (not shown) positioned at an angle of between about one degree and ninety degrees relative to each other. Additionally, the unibody cutting surface (not shown) can contain one or more first cutting members (not shown) and one or more second cutting members (not shown). The one or more first cutting members (not shown) and one or more second cutting members (not shown) can be a conventional razor, a blade, a serrated blade, a metal wire, a plastic fiber, a composite fiber, a plastic blade, a composite material or some other device having an surface that can be used for cutting. Additionally, the one or more first cutting members (not shown) and one or more second cutting members (not shown) may be of similar or different materials.

The cutting apparatus can be made by preparing an assembly having a first cutting member holder having one or more slots extending inwardly. One or more first cutting members then positioned to extend into the one or more slots. The one or more first cutting members are disposed in or about the first cutting member holder. One or more second cutting members are oriented to extend generally perpendicular to the one or more first cutting members. The one or more second cutting members are then disposed in or about the first cutting member holder.

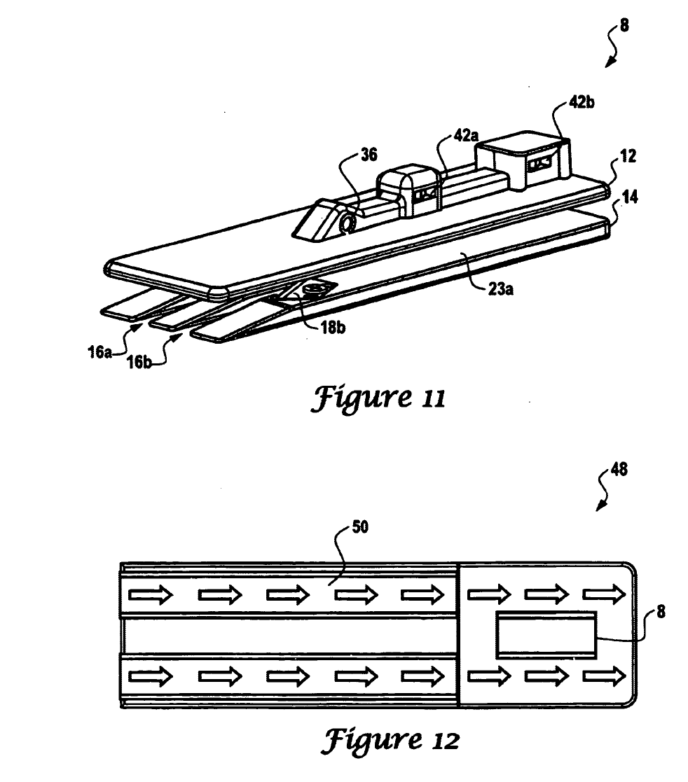

FIG. 12 illustrates a top view of an automated cutting system 48. The automated cutting system 48 includes a transport mechanism 50 (e.g., a conveyer belt, roller mechanism, table or other mechanisms known in the art). The transport mechanism may include a motor that is powered (e.g., an electric motor, battery, solar cell or manually powered) to drive the transport mechanism. The transport mechanism 50 conveys materials to be cut (not shown) into contact with a cutting apparatus 8. The cutting apparatus 8 may be handheld or connected to the transport mechanism 50. Alternatively, the cutting apparatus 8 may be connected (not shown) to a table, movable arm, robotic machine or other mechanism known in the art. The automated cutting system 48 may also include a control mechanism (e.g., a computer, a electric eye, a counter, or manually operation) which regulates the advance of the transport system 50.

The cutting apparatus 8, includes a handle (not shown) disposed on or about an upper member (not shown). A first cutting member holder (not shown) is attached generally parallel to the upper member (not shown). The first cutting member holder (not shown) has one or more slots (not shown) extending inward from one end. The one or more slots (not shown) can be located at either or both ends of the first cutting member holder (not shown). One or more first cutting members (not shown) are disposed in or about the first cutting member holder (not shown) and extend into the one or more slot (not shown). The first cutting member holder (not shown) can be configured in different combinations of one or more slots (not shown) with one or more first cutting members (not shown). In some instances, the first cutting member holder (not shown) has one or more first cutting members (not shown) extending in each of the one or more slots (not shown). In other instances the first cutting member holder (not shown) has one first cutting member (not shown) extend into all of the one or more slots (not shown) (e.g., one slot and one first cutting member, one slot and multiple first cutting members, multiple slots and one first cutting member, multiple slots and multiple first cutting members).

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations can be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

1. A cutting apparatus comprising:
a first cutting member holder having one or more slots extending inwardly;
one or more first cutting members disposed in or about the first cutting member holder extending into the one or more slots;
a second cutting member holder disposed in or about the first cutting member holder and extending generally perpendicular to the one or more first cutting members; and
one or more second cutting members disposed on or about the second cutting member holder.

2. The apparatus of claim 1, further comprising an upper member connected to the second cutting member holder and extending generally parallel to the first cutting member holder, whereby one or more longitudinal groves are formed between the upper member and the first cutting member holder.

3. The apparatus of claim 2, further comprising a handle disposed on the upper member.

4. The apparatus of claim 3, wherein the handle is ergonomically shaped.

5. The apparatus of claim 1, further comprising one or more yokes, one or more knobs or one or more handles attached on or about the apparatus.

6. The apparatus of claim 5, wherein the one or more handles are removable.

7. The apparatus of claim 1, wherein the first cutting member holder or the second cutting member holder is constructed from a material selected from the group consisting of a polymer, a plastic, an alloy, a metal, a composite, a graphite, a stone, and a wood.

8. The apparatus of claim 1, wherein the thickness at the middle of the first cutting member holder is greater than the thickness at the ends of the first cutting member holder.

9. The apparatus of claim 1, wherein the first cutting member holder further comprises one or more first cutting member recesses, for receiving the one or more first cutting members.

10. The apparatus of claim 1, wherein the one or more first cutting member extends into the one or more slots forming an angle of between about 0 and 90 degrees relative to the one or more slots.

11. The apparatus of claim 1, wherein the one or more second cutting members are positioned to form an angle of between about 1 and 90 degrees relative to the first cutting member holder.

12. The apparatus of claim 1, wherein the one or more first cutting members are fitted frictionally, removably fitted or secured in or about the first cutting member holder.

13. The apparatus of claim 1, wherein the one or more second cutting members are fitted frictionally, removably fitted or secured in or about the second cutting member holder.

14. The apparatus of claim 1, where in the one or more first cutting member or the one or more second cutting member are selected from the group consisting of a wire, a blade, a serrated surface, a razor blade and an other device having an edge.

15. A cutting apparatus comprising:
a first planar member having a leading edge and one or more longitudinal slots in the leading edge;
a second planar member attached to a top surface of the first planar member at a generally perpendicular angle to the leading edge and the top surface of the first planar member;
a first cutting member disposed in or about the one or more longitudinal slots; and
a second cutting member disposed on or about a leading edge of the second planar member.

16. The apparatus as recited in claim 15, wherein the first planar member and second planar member form an integrated blade holder.

17. The apparatus of claim 15, wherein the cutting members extend generally perpendicular.

18. The apparatus of claim 15, wherein the angle formed between the second cutting member and the second planar member is between about one and ninety degrees.

19. The apparatus of claim 15, further comprising one or more yokes or one or more handles attached on or about the apparatus.

20. A method of making a cutting apparatus comprising the steps of:
preparing an assembly having a first cutting member holder having one or more slots extending inwardly;
positioning one or more first cutting members to extend into the one or more slots; disposing the one or more first cutting members in or about the first cutting member holder;
positioning the one or more second cutting members to extend generally perpendicular to the one or more first cutting member; and
disposing the one or more second cutting members in or about the first cutting member holder.
